(19) United States
(12) Patent Application Publication
(10) Pub. No.: US 2023/0342710 A1
(43) Pub. Date: Oct. 26, 2023

(54) INTELLIGENT MANUFACTURING DIVISION SYSTEM

(71) Applicant: Dell Products L.P., Round Rock, TX (US)

(72) Inventors: Shibi Panikkar, Bangalore (IN); Rohit Gosain, Bangalore (IN)

(73) Assignee: Dell Products L.P., Round Rock, TX (US)

(21) Appl. No.: 17/660,224

(22) Filed: Apr. 22, 2022

(51) Int. Cl. G06Q 10/08

(52) U.S. Cl. CPC G06Q 10/087

(57) ABSTRACT

A method comprising: identifying an order for a product; dividing the order into order portions and assigning each of the order portions to a different respective supplier; adjusting each of the order portions based on a capacity of the respective supplier to which the order portion is assigned; and returning the order portions after the order portions have been adjusted, wherein adjusting any given one of the order portions includes identifying a term that is associated with the given order portion, dividing the given order portion into a plurality of daily quantities that correspond to different respective days in the term, and reducing any given one of the daily quantities that fails to meet a corresponding daily capacity of the respective supplier to which the given order portion is assigned.

### BACKGROUND

When a company places an order for a product, the company may divide the order between multiple original design manufacturers (ODMs). Dividing the order in this manner is advantageous because it puts the company in a better negotiating position and reduces risks associated with the fulfillment of the order. Such risks may arise from the inability of different ODMs to complete the order on time or complete the order according to other specified parameters.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

According to aspects of the disclosure, a method is provided comprising: identifying an order for a product; dividing the order into order portions and assigning each of the order portions to a different respective supplier; adjusting each of the order portions based on a capacity of the respective supplier to which the order portion is assigned; and returning the order portions after the order portions have been adjusted, wherein adjusting any given one of the order portions includes identifying a term that is associated with the given order portion, dividing the given order portion into a plurality of daily quantities that correspond to different respective days in the term, and reducing any given one of the daily quantities that fails to meet a corresponding daily capacity of the respective supplier to which the given order portion is assigned.

According to aspects of the disclosure, a method is provided comprising: identifying an order for a product; dividing the order into order portions and assigning each of the order portions to a different respective supplier; adjusting each of the order portions based on a capacity of the respective supplier to which the order portion is assigned; and returning the order portions after the order portions have been adjusted, wherein adjusting any given one of the order portions includes identifying a term that is associated with the given order portion, dividing the given order portion into a plurality of fractional quantities that correspond to different respective portions of the term, and reducing any given one of the fractional quantities that fails to meet a corresponding fractional capacity of the respective supplier to which the given order portion is assigned.

According to aspects of the disclosure, a system is provided comprising: a memory; and at least one processor operatively coupled to the memory, the at least one processor being configured to perform the operations of: identifying an order for a product; dividing the order into order portions and assigning each of the order portions to a different respective supplier; adjusting each of the order portions based on a capacity of the respective supplier to which the order portion is assigned; and returning the order portions after the order portions have been adjusted, wherein adjusting any given one of the order portions includes identifying a term that is associated with the given order portion, dividing the given order portion into a plurality of fractional quantities that correspond to different respective portions of the term, and reducing any given one of the fractional quantities that fails to meet a corresponding fractional capacity of the respective supplier to which the given order portion is assigned.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a system, according to aspects of the disclosure;

FIG. 2 is a diagram of a purchaser system, according to aspects of the disclosure;

FIG. 3 is a flowchart of an example of a process, according to aspects of the disclosure;

FIG. 4 is a flowchart of an example of a process, according to aspects of the disclosure;

FIG. 5 is a flowchart of an example of a process, according to aspects of the disclosure;

FIG. 6A is a flowchart of an example of a process, according to aspects of the disclosure;

FIG. 6B is a flowchart of an example of a process, according to aspects of the disclosure;

FIG. 7 is a flowchart of an example of a process, according to aspects of the disclosure; and

FIG. 8 is a diagram illustrating the operation of a purchaser system, according to aspects of the disclosure

### DETAILED DESCRIPTION

According to aspects of the disclosure, a system is provided for dividing an order among multiple original design manufacturers (ODMs). When determining the respective sizes of individual order portions, the system may take into consideration various factors, such as parts availability and ODM capacity. Using the system to divide orders is advantageous, in comparison to some existing systems, because it may lower the rate of ODM order rejections.

In general, when a purchase order is divided among multiple ODMs, each ODM may reject the portion of the order that is assigned to it. For example, a given ODM may reject an order (or order portion) when the ODM is unable to fulfill the order (or order portion). Receiving a rejection from the given ODM may be inconvenient to the purchaser because it may necessitate the entire process for dividing the order to be repeated. Moreover, the rejection may require the cancelation/modification of existing orders (or order portions) that are placed with other ODMs. For example, it may require the orders (or order portions) that are placed with other ODMs to be increased in order to make up for the given ODM's inability to meet its assigned quota. In this regard, by reducing the rate of order rejections, the system may streamline the operations of companies' purchasing departments and increase productivity.

As used throughout the disclosure, the terms “order” and “order portion” may be used interchangeably when permitted by context. When a large order is divided into portions and each portion submitted to a different ODM, each order portion in fact becomes a separate order that is fulfilled separately by its respective ODM.

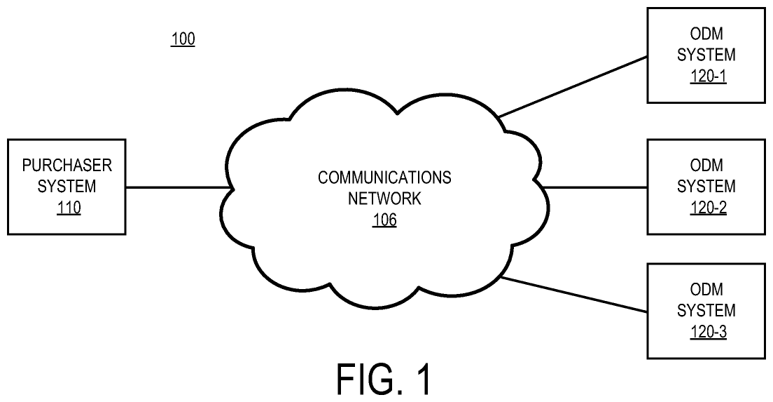

FIG. 1 is a diagram of an example of a system 100, according to aspects of the disclosure. As illustrated, system 100 may include a purchaser system 110 and a plurality of ODM systems 120 that are coupled to one another via a communications network 106. The communications network 106 may include one or more of a local area network (LAN), a wide area network (WAN), a cellular network (e.g., a 5G network), the Public Switched Telephone Network (PTSN), the Internet, and/or any other suitable type of communications network. The purchaser system 110 may include one or more of a desktop computer, a laptop computer, a smartphone, and/or any other suitable type of electronic device or system. Each of the ODM systems may include one or more of a desktop computer, a laptop computer, a smartphone, and/or any other suitable type of electronic device or system. The purchaser system 110 may be operated by personnel in the purchasing department of a company. Each of the ODM systems 120 may be operated by the personnel of a different ODM, and it may be used to receive purchase orders. In some implementations, the ODM system 120-1 may be associated with a first ODM, the ODM system 120-2 may be associated with a second ODM, and the ODM system 120-3 may be operated by a third ODM.

In operation, the purchaser system 110 may receive as input an order specification. The order specification may identify a product and a quantity of the product that is desired to be purchased. In response to the input, the purchaser system 110 may divide the order into portions and assign each of the portions to a different one of the ODMs. Afterward, the purchaser system 110 may place each order portion with the portion's respective ODM. The placement of each order portion may include transmitting a message to the order portion's assigned ODM. The message may identify a quantity of a product that is desired to be purchased and/or any other suitable information.

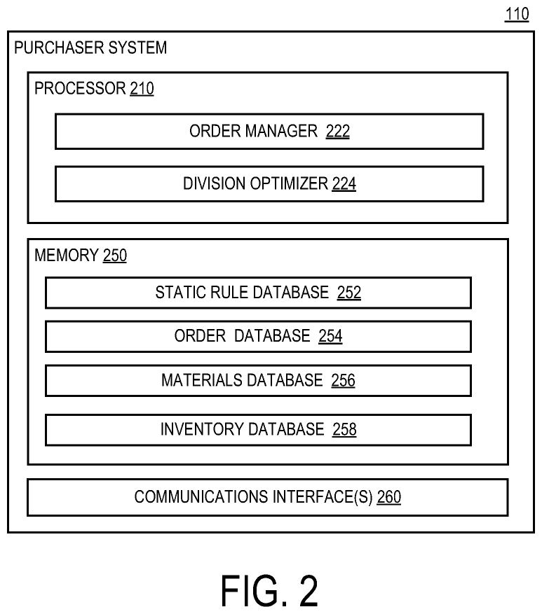

FIG. 2 shows the purchaser system 110 in further detail. The system 110 may include a processor 210, a memory 250, and a communications interface 260. The processor 210 may include any of one or more general-purpose processors (e.g., x86 processors, RISC processors, ARM-based processors, etc.), one or more Field Programmable Gate Arrays (FPGAs), one or more application-specific circuits (ASICs), and/or any other suitable type of processing circuitry. The memory 250 may include any suitable type of volatile and/or non-volatile memory. In some implementations, the memory 250 may include one or more of a random-access memory (RAM), a dynamic random memory (DRAM), a flash memory, a hard drive (HD), a solid-state drive (SSD), a network accessible storage (NAS), and or any other suitable type of memory device. The communications interface 260 may include any suitable type of communications interface, such as one or more Ethernet adapters, one or more Wi-Fi adapters (e.g., 802.1414 adapters), and one or more Long-Term Evolution (LTE) adapters, for example.

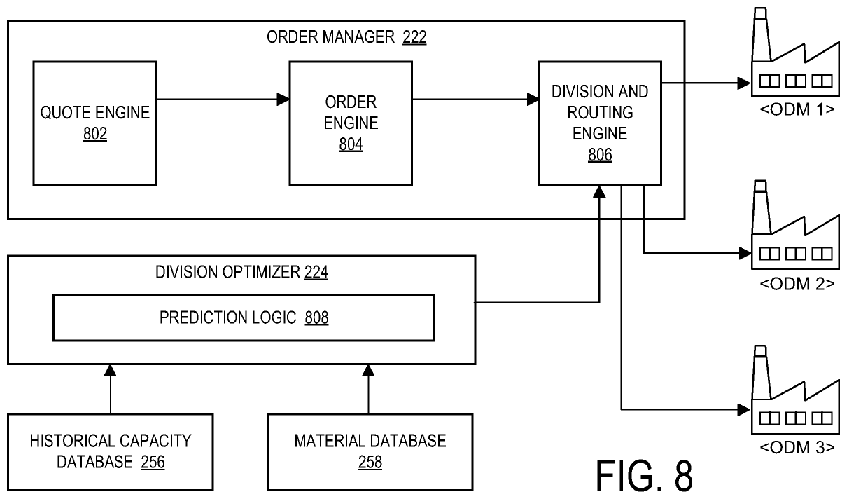

The processor 210 may be configured to execute an order manager 222 and a division optimizer 224. The operation of the order manager 222 and division optimizer 224 is discussed in further detail with respect to FIG. 8. The memory 250 may be configured to store a static rule database 252, an order database 254, a materials database 256, and an inventory database 258.

The static rule database 252 may identify respective static division rules for different products. A static division rule for a product is a rule that specifies the manner in which an order for a product should be divided among different ODMs that can supply the product. For example, any time a new quantity of the product is desired to be manufactured/procured, the static rule may specify what portion of the new quantity should be manufactured by which ODMs. In some implementations, database 252 may include a plurality of entries. Each entry may be associated with a different respective product, and it may identify a static division rule for the entry's corresponding product.

In some implementations, any of the static division rules that are stored in the database 252 may be agnostic with respect to supplier capacity. An example of a product may be a “Model A” laptop. A static division rule for the “Model A” laptop may be 40%:20%:40%. Such rule may specify that every time a new quantity of the “Model A” laptop needs to be manufactured (or procured), 40% of the new quantity should be ordered from a first ODM, 20% of the new quantity should be ordered from a second ODM, and 40% of the new quantity should be ordered from a third ODM.

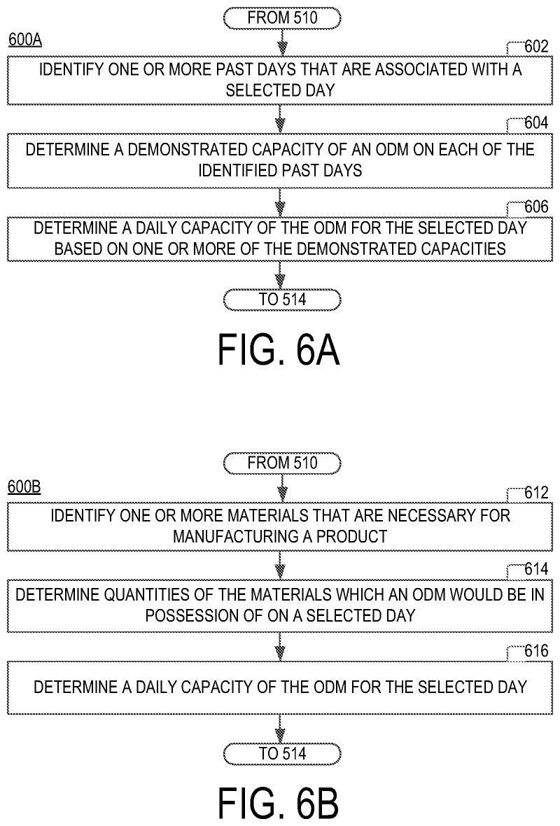

The prior order database 254 may include historical records of orders that have been placed with different ODMs in the past. Each historical record for an order may identify: (i) a product that was ordered, (ii) a quantity of the product that was ordered, (iii) a term (or period) of the order, (iv) the ODM with which the order was placed, and (v) whether the ODM accepted the order or rejected it. As is discussed further below with respect to FIG. 6A, the records in database 254 may be used to determine the capacities of different ODMs. Although in the present example ODM capacities are estimated by using the order database 254, alternative implementations are possible in which the values of ODM capacities are reported by the ODMs directly. Stated succinctly, the present disclosure is not limited to any specific method for determining ODM capacity.

The materials database 256 may include material sheets for different products. As used herein, the term “materials” may refer to parts, raw materials, and/or any other components that are needed to manufacture a particular product. In some respects, the materials database 256 may be used to identify the materials which an ODM needs to possess in order to manufacture a particular product.

The inventory database 258 may include a plurality of inventory records. The inventory records may be used to determine (or estimate) if an ODM is in possession of sufficient inventory to fulfill an order. Each of the inventory records may be associated with a different ODM. Each of the inventory records may identify the materials (and corresponding amounts), which the associated ODM is in possession of or expected to be in possession of. The present disclosure is not limited to populating the inventory database 258 in any specific manner. In some instances, when a purchaser places an order with an ODM, the purchaser may also order the materials for the order to be shipped to the ODM. In such instances, the purchaser may update the database 258 when material orders are placed. In other instances, the purchaser may receive inventory information from the ODMs and update the database with the received information. Stated succinctly, the present disclosure is not limited to any specific method for updating the database 258.

As used herein the, term “database” may refer to one or more data structures for storing information. A database may include an object or a plurality of objects. As another example, a database may include a file or a plurality of files. As yet another example, a database may include a folder or a plurality of folders. As yet another example, a database may include a relational database, such as a MySQL database, or a non-relational database. Stated succinctly, the present disclosure is not limited to any specific implementation of the databases 252-258. Although databases 252-258 are depicted as hosted on the system 110, alternative implementations are possible in which any of databases 252-258 is hosted externally of the system 110.

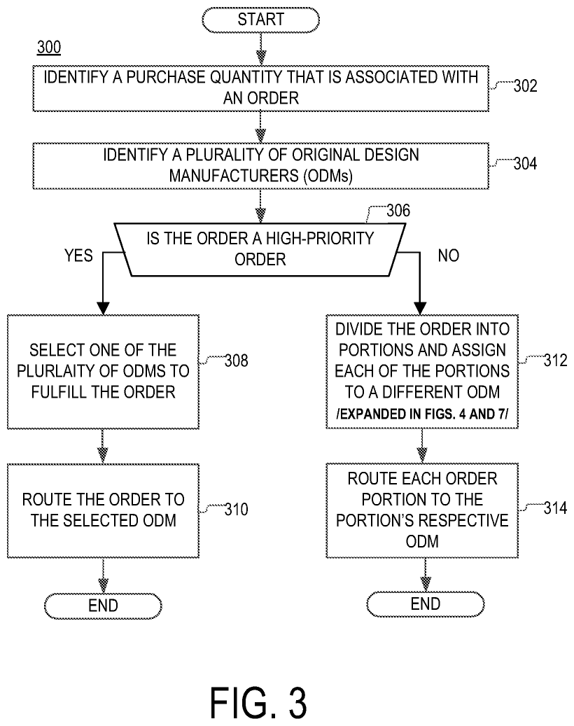

FIG. 3 is a flowchart of an example of process 300, according to aspects of the disclosure.

At step 302, the system 110 identifies a purchase quantity that is associated with an order. The purchase quantity may be the total quantity of a product that is desired to be ordered from one or more ODMs. Identifying the purchase quantity may include receiving the purchaser quantity via an input device (e.g., a keyboard or mouse) of the system 110 or retrieving the purchase quantity from a particular memory location.

At step 304, the system 110 identifies a plurality of ODMs that are capable of fulfilling the order. The plurality of ODMs may be identified by using the database 252 or another database that identifies potential suppliers for a product.

At step 306, the system 110 determines if the order is a high-priority order. A high priority order may be a must-arrive-by-date (MADB) order, and/or any other order that is accorded high importance. If the order is a high-priority order, the process 300 proceeds to step 308. Otherwise, if the order is not a high-priority order, the process 300 proceeds to step 312.

At step 308, the system 110 selects one of the plurality of ODMs to fulfill the order. According to the present example, the system 110 may determine the respective capacity of each of the plurality of ODMs and select the ODM having the largest capacity. However, the present disclosure is not limited to using any specific criterion for selecting an ODM.

At step 310, the system 110 routes the order to the ODM (selected at step 308). In some implementations, routing the order may include transmitting an indication of the order from the system 110 to one of systems 120, which corresponds to the selected ODM.

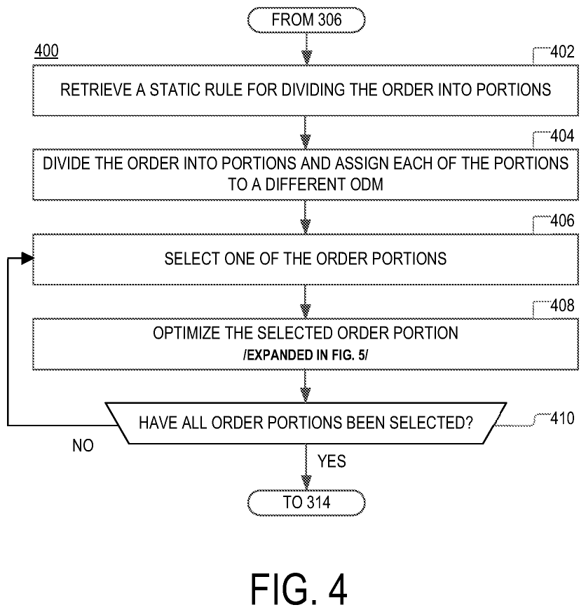

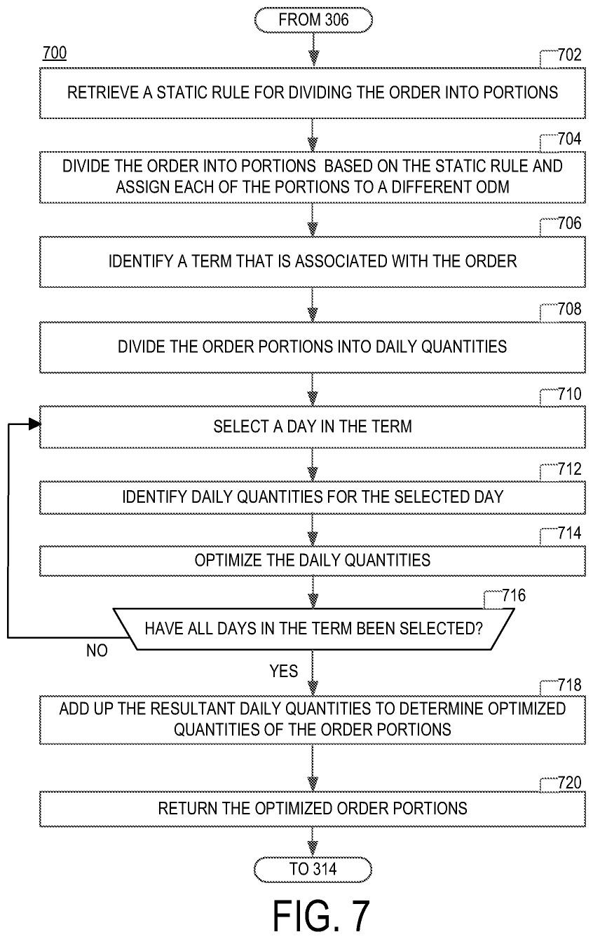

At step 312, the system 110 divides the order into a plurality of portions and assigns each of the portions to a different one of the plurality of ODMs. In some implementations, step 312 may be performed in the manner discussed with respect to FIGS. 4 and 7.

At step 314 each of the order portions is routed (as a separate order) to a different respective ODM. Specifically, each of the order portions is routed to the ODM to which the order portion is assigned. As noted above, routing an order portion to an ODM may include placing a separate purchase request (or order) for the quantity associated with the order portion with ODM to which the order portion is assigned. Placing a purchase request with a given ODM may include transmitting the purchase request (over network 106) from system 110 to one of the systems 120 that is associated with the given ODM. The purchase request may identify the quantity of the product that is desired to be purchased and/or any other suitable information.

FIG. 4 is a flowchart of an example of a process 400 for dividing an order into portions, as specified by step 312 of process 300.

At step 402, system 110 retrieves a static division rule for dividing the order into portions. In some implementations, the static division rule may be one that is associated with the product (i.e., the product associated with the purchase quantity identified at step 302). In some implementations, the static division rule may be selected out of a plurality of available static division rules, where each of the static division rules is associated with a different product. In some implementations, the static division rule may be retrieved from database 252 (shown in FIG. 2). In some implementations, the static division rule may be retrieved as a result of performing a search of the database 252 based on an identifier of the product.

At step 404, the order is divided into portions based on the static division rule, and each of the portions is assigned to a different respective ODM. Consider an example in which the purchase is for 1000 laptops, and the rule specifies a 40:35:25 division between a first ODM, a second ODM, and a third ODM. In such implementations, dividing the order into portions may include: (i) splitting the purchase quantity of the order (e.g., 1000) into three portions of sizes 400, 350, and 250, respectively (ii) assigning the quantity of 400 laptops to the first ODM, (iii) assigning the quantity of 350 laptops to the second ODM, and (iv) assigning the quantity of 250 laptops to the third ODM.

At step 406, one of the order portions is selected.

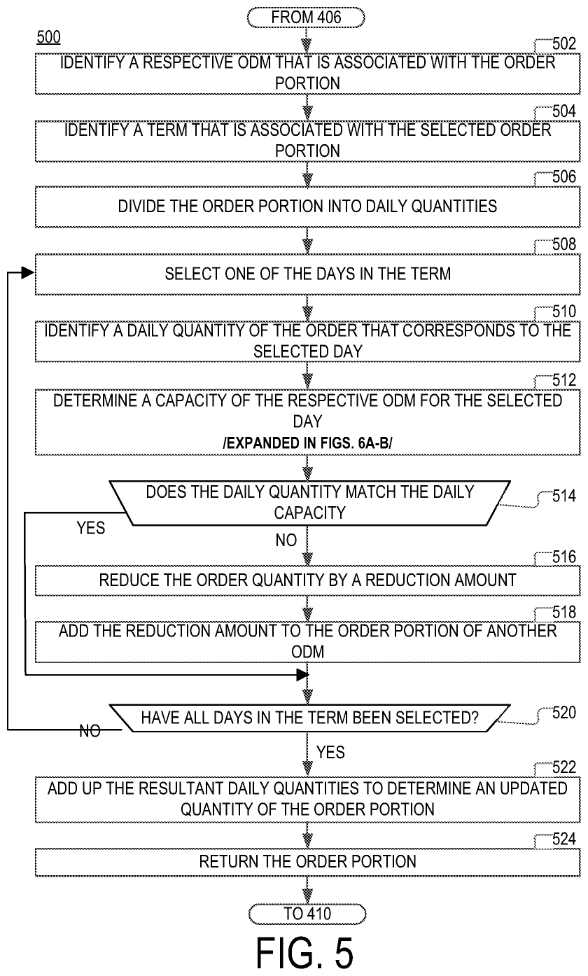

At step 408, the selected order portion is optimized. Optimizing the selected order portion may include: (i) detecting whether the ODM assigned to the selected order portion has the capacity to fulfill the order portion, (iii) reducing the order portion when the ODM is found to lack capacity, and (iii) leaving the order portion unchanged when the ODM is found to possess sufficient capacity. In some implementations, step 408 may be performed in the manner discussed with respect to FIG. 5.

At step 410, a determination is made if all order portions have been selected. If all order portions have been selected, process 400 returns to step 314. Otherwise, process 400 returns to step 406, and another one of the order portions is selected. The selected order portion may be one that has not been selected during a prior iteration of step 406.

FIG. 5 is a flowchart of an example of a process 500 for optimizing an order portion as specified by step 408 of process 400.

At step 502, a respective ODM that is associated with the order portion is identified. Specifically, at step 502, the ODM to which the order is assigned (at step 404) is identified.

At step 504, a term that is associated with the order portion is identified. The term may correspond roughly to the period in which the order portion is expected to be pending. In some implementations, the term may be the period starting when the order portion is expected to be submitted to the respective ODM (identified at step 502) and ending when the order is fulfilled. Alternatively, in some implementations, the term may be the period starting when the respective ODM (identified at step 502) is expected/required to begin manufacturing the order portion and ending when the respective ODM is expected/required to have produced the entire quantity of the order portion. It will be understood that the present disclosure is not limited to any specific definition for the term of an order portion.

At step 506, the order portion is divided into daily quantities. In some implementations, dividing the order into daily quantities may include identifying the respective quantity of the product which is required to be manufactured by the respective ODM in each of the days in the term. Additionally or alternatively, in some implementations, dividing the order portion into daily quantities may include dividing the quantity of the order portion (e.g., 400 laptops) by the number of days in the term (identified at step 404). In some implementations, the daily quantity for each day in the term may be the same. Alternatively, in some implementations, the daily quantities for any two days in the term may be different. In some implementations, dividing the order into daily quantities may include receiving as input a list (or schedule) of the quantitates which the respective ODM is expected/required to manufacture (or supply) in each (or at least some) of the days in the term.

At step 508, one of the days in the term is selected.

At step 510, a daily quantity is identified which corresponds to the selected day. As noted above, the identified daily quantity may be one that the ODM is expected/required to manufacture in the selected day.

At step 512, the capacity of the ODM for the selected day is determined. The capacity of the ODM for the selected day may be the maximum quantity that the ODM is capable of producing (or expected to be able to produce) in the selected day. The capacity may be determined based on at least one of: (i) historical records of prior orders that have been placed with the ODM, and (ii) availability of materials. In some implementations, the daily capacity of the ODM may be the lower of the daily capacity determined based on historical records and the daily capacity that is determined based on the availability of materials. FIG. 6A, which is discussed further below, provides an example of a process for determining the daily capacity of an ODM based on historical records, and FIG. 6B provides an example of a process for determining daily capacity based on the availability of materials.

At step 514, a determination is made if the daily quantity (determined at step 510) matches the daily capacity (determined at step 512). According to the present disclosure, the daily quantity is determined to match the daily capacity if the daily quantity is less than or equal to 80% of the daily capacity. If the daily quantity exceeds 80% of the daily capacity, the daily quantity is said to not match the daily capacity. According to the present example, 80% of the daily capacity is the threshold limit for assessing a match between a daily capacity and a daily quantity. The present disclosure is not limited to any specific value for the threshold limit. For example, the threshold limit may be equal to 100% of the daily capacity or 50% of the daily capacity, etc. If the daily quantity is determined to match the daily capacity, process 500 proceeds to step 520. Otherwise, if the daily quantity does not match the daily capacity, the process 500 proceeds to step 516.

At step 516, the daily quantity is reduced by an amount that is sufficiently large to bring the daily quantity under the threshold limit (e.g., 80% of daily capacity). For example, if the daily capacity is 40 laptop units and the daily quantity is 42 laptop units, the daily quantity may be reduced by 10 laptop units to bring the daily quantity under the threshold limit. Under the nomenclature of the present disclosure, the amount by which a daily quantity is reduced is referred to as “reduction amount”.

At step 518, the reduction amount (determined at step 516) is added to another one of the order portions (determined at step 404). Specifically, at step 518, the reduction amount is added to one of the other order portions (determined at step 404), and, as a result, is transferred from the respective ODM (identified at step 502) to another ODMs that is assigned the other order portion. In some implementations, assigning the reduction amount includes identifying an ODM that has sufficient capacity to accept the reduction amount, and adding the reduction amount to the product quantity that would be ordered from the identified ODM. If none of the other ODMs has sufficient capacity, the system 110 may increase the threshold limit of the respective ODM or output an error message.

At step 520, a determination is made if all days in the term (identified at step 504) have been selected (at step 508). If all days have been selected, the process 500 proceeds to step 522. Otherwise, the process 500 returns to step 508 and another one of the days is selected. The selected day may be one that has not been selected in an earlier iteration of step 508.

At step 522, an updated quantity of the order portion is determined by adding up the daily quantities for the order portion, which are obtained at different iterations of step 510 and potentially adjusted at steps 516-514. In some implementations, the updated quantity may also include any reduction amounts that have been added to the order portion as a result of an execution of the process 500 with respect to other order portions.

At step 524, the (optimized) order portion is returned. Returning the order portion may include one or more of: storing the respective quantity (calculated at step 522) in a predetermined location in a memory, displaying the quantity on a display device, transmitting the quantity over a communications network, and/or any other suitable type of action.

FIG. 6A is a flowchart of a process 600A for determining the capacity of an ODM based on historical records, as discussed above with respect to step 512 of the process 500. The ODM whose daily capacity is determined is the one identified at step 502 of the process 500.

At step 602, the system 110 identifies one or more past days that are associated with a selected day. The selected day may be the one selected at step 508, and it may lie in the future. The identified days may be in the past. For example, if the selected day is Mar. 25, 2022, the identified days may include Mar. 25, 2021, Mar. 25, 2020, March 2019, etc. As another example, if the selected day is Mar. 25, 2022, the identified days may include only Mar. 25, 2020. As yet another example, if the selected day is the last Friday in March 2022, the selected days may be the last Friday of March 2021, the last Friday of March 2020, and the last Friday of March 2019. In some respects, the selected day(s) may be day(s) on which the ODM (i.e., the ODM identified at step 502) is projected to have experienced the same demand as it would on the selected day.

At step 604, system 110 identifies a demonstrated capacity of the ODM on each of the past days. Specifically, the system 110 may perform a search of database 254 to identify historical records of orders for the same or similar products. The system 110 may determine the past days' corresponding daily quantities based on the historical records. The system 110 may use the past day's corresponding daily quantities as a basis for determining the daily capacity of the ODM (identified at step 502) for the day (selected at step 508). As noted, the past days may be days on which the ODM is expected to have experienced similar demand fluctuations (and other operational fluctuations) as it would on the selected day. In this regard, using the daily quantities for the past days to estimate the daily capacity for the selected day may yield a more accurate estimate than otherwise.

In one aspect, the historical records may be associated with orders for the same product (i.e. the product associated with the order identified at step 302). Additionally or alternatively, in some implementations, the historical records may be associated with orders for the same or similar products. For instance, if the order received at step 302 is for a ‘Model A’ laptop, the historical records may correspond for orders for the ‘Model A’ laptop, a ‘Model B’ laptop, and a ‘Model C’ laptop. In some implementations, associated models may be identified based on a database that identifies groupings of products, which are considered similar for the purposes of determining demonstrated manufacturing capacity. It will be understood that the present disclosure is not limited to any specific method for identifying similar products.

In another aspect, each of the historical records may be associated with a corresponding order. The corresponding order may have an associated term (e.g., an associated period). The associated term of any order/order record may be used as a basis for selecting the order record for use in determining demonstrated capacity. Specifically, in some implementations, each of the historical records used for determining demonstrated capacity may correspond to an order whose term includes one or more of the past days (identified at step 602). In other words, in some implementations, only order records whose term includes the past days (identified at step 602) may be selected and used for determining the daily capacity for the day selected at step 508.

In yet another aspect, each of the orders whose records are retrieved at step 604 may be an order that is submitted to the same ODM (i.e., the ODM identified at step 502). In some implementations, each of the orders may have been generated by executing one of the processes 400 and 700 and/or any other process for dividing a larger order among multiple ODMs.

In yet another aspect, the system 110 may process each of the identified order records. As a result of the processing, the system 110 may identify the daily quantity (of that order/record) on each of the past days (identified at step 602). As noted above, the daily quantity of an order for a particular day may be determined by dividing the entire quantity of the order by the duration of the term (e.g., as measured in days) or in any other suitable manner.

In yet another aspect, the daily quantities (determined at step 604) in orders that were not rejected (and which were fulfilled) constitute different instances of demonstrated capacity by the ODM. The daily quantities (determined at step 604) effectively serve to identify the daily capacity of the ODM (identified at step 502) for the day (selected at step 508). In other words, in one aspect of the disclosure, the demonstrated daily capacities of an ODM, for days that are related in terms of demand and other fluctuations, to a day in the future (selected at step 508), are used to determine the capacity of the ODM for the day in the future.

At step 606, the system 110 determines the daily capacity of the ODM (identified at step 502) for the day selected at step 508. The daily capacity may be determined based on one or more of the daily quantities (identified at step 604). For example, the daily quantities for any orders that have been rejected by the ODM may be considered to be above the capacity of the ODM for the selected day. As yet another example, the daily capacity of the ODM for the selected day may be set to equal the largest one (or only one) of the daily quantities for orders that have been accepted by the ODM (i.e., orders whose records are identified at step 604). As yet another example, the daily capacity of the ODM for the selected day may be set to equal the weighted sum of the n largest ones of the daily quantities (determined at step 604). As yet another example, the daily capacity of the ODM for the selected day may be calculated by weighting the largest daily quantity for an order that was accepted/fulfilled. Stated succinctly, the present disclosure is not limited to any specific method for calculating the daily capacity of the ODM based on past daily quantities.

FIG. 6B is a flowchart of a process 600B for determining the capacity of an ODM based on available inventory, as discussed above with respect to step 512 of the process 500. At step 612, the system 110 identifies one or more materials that are necessary for making the product. The materials may be identified by using database 256 (shown in FIG. 2). At step 614, the system 110 identifies quantities of the materials which the ODM would be in possession of on the selected day (i.e., the day selected at step 508). The quantities may be obtained by using database 258 (shown in FIG. 2). At step 616, the system 110 determines the daily capacity of the ODM (identified at step 502) for the day (selected at step 508). According to the example of FIG. 6B, the daily capacity is the maximum quantity of the product that the ODM can manufacture with the quantities of the materials which would be available to the ODM on the selected day.

FIG. 7 is a flowchart of an example of a process 700, according to aspects of the disclosure.

At step 702, the system 110 retrieves a static division rule for dividing the order (identified at step 302) into portions. In some implementations, step 702 may be performed in the same or similar manner as step 402 of the process 400.

At step 704, the order is divided into portions based on the static division rule, and each of the portions is assigned to a different respective ODM. In some implementations, step 704 may be performed in the same or similar manner as step 404 of the process 400.

At step 706, a term (e.g., a period) associated with the order portion is identified. In some implementations, step 706 may be performed in the same or similar manner as step 504 of the process 500. In some implementations, the term of an order may be the same as the term of each of the order portions.

At step 708 each of the order portions is divided into respective daily quantities. In some implementations, each of the order portions may be divided into daily quantities in the manner discussed above with respect to step 506 of the process 500.

At step 710, a day in the term (identified at step 706) is selected.

At step 712, a respective daily quantity is identified for the selected day for each of the order portions. Each of the daily quantities may be associated with a different one of order portions (identified at step 704). Each of the daily quantities may be associated with the selected day (i.e., the day selected at step 710). In some implementations, each of the daily quantities may be determined in the manner discussed above with respect to step 510 of the process 500.

At step 714, each of the daily quantities (identified at step 712) is optimized. In some implementations, the optimization of each of the daily quantities may be performed in the manner discussed with respect to steps 512-518 of the process 500. As a result of executing step 714, any one of the daily quantities that exceed the threshold limit of the quantity's respective ODM may be reduced by a reduction amount that is sufficient to bring the quantity below the threshold limit of the respective ODM. The reduction amount may be subsequently added to the order portion of another one of the ODMs, which has sufficient capacity to accommodate the reduction amount. A given ODM may have sufficient capacity to accommodate the reduction amount if adding the reduction amount to the given ODM's order portion (or a particular daily quantity) would not cause the given ODM's daily quantity to cross the given ODM's threshold limit on any day of the term. If none of the other ODMs has sufficient capacity, the system 110 may increase the threshold limit of the respective ODM or output an error message.

At step 716, a determination is made if all days in the term (identified at step 706) have been selected (at step 710). If all days have been selected, the process 700 proceeds to step 718. Otherwise, the process 700 returns to step 710 and another one of the days is selected. The selected day may be one that has not been selected in an earlier iteration of step 710.

At step 718, for each of the order portions, the daily quantities that remain (or result) after all iterations of steps 712-714 are completed are added up to determine an optimized value for the order portion. For example, all daily quantities (increased, decreased, or unchanged) that correspond to a first order portion may be added up to determine an optimized quantity of the first order portion. As another example, all daily quantities (increased, decreased, or unchanged) that correspond to a second order portion may be added up to determine an updated quantity for the first second portion. As used herein, the terms “order portion” and “quantity of the order portion” are used interchangeably to denote the quantity of a product that is intended to be procured from the same ODM. Depending on the circumstances, the optimized quantity of an order portion may be the same as the original quantity or it may be greater than or less than the original quantity.

At step 720, the (optimized) order portions are returned. Returning the order portions may include one or more of storing the respective quantities (calculated at step 718) in a predetermined location in a memory, displaying the quantities on a display device, transmitting the quantities over a communications network, and/or any other suitable type of action.

FIG. 8 is a diagram illustrating the operation of the system 110. As illustrated, the order manager 222 may include a quote engine 802, an order engine 804, and a division and routing engine 806. The quote engine 802 may be configured to interact with different ODM systems to obtain quotes on a product from different ODMs. The order engine 804 may be configured to determine an order quantity and select the ODMs which would be asked to manufacture different portions of the order quantity. The division and routing engine 806 may be configured to (i) determine the respective product quantities that would be ordered from different ones of the selected ODMs and (ii) order the quantities from their respective ODMs. In some implementations, the engine 806 may use the division optimizer 224 to determine the order quantities that are ordered from different ODMs. The division optimizer 224 may be configured to execute optimization logic 808. The optimization logic 808 may be configured to determine the order quantities by executing any of the processes 400-700, which are discussed above, with respect to FIGS. 4-7.

FIGS. 1-8 are provided as an example only. At least some of the steps discussed with respect to FIGS. 1-8 may be performed in parallel, performed in a different order, or altogether omitted. In the example of FIGS. 1-8 an order term is divided into days, and corresponding daily quantities and capacities are determined and used as a basis for adjusting order portions. However, alternative implementations are possible in which an order term is divided into other portions (e.g., 6-hour portions or 4-hour portions). In such implementations, fractional quantiles may be determined by dividing a count of term portions over an order quantity or in any other suitable manner for estimating what fraction of an order quantity should an ODM be able to manufacture in a given term order. Furthermore, in such implementations ODM capacities may be determined for different term portions (e.g., 6-hour ODM capacities or 4-hour capacities). Such ODM capacities, in combination with the fractional quantities, may be used as a basis for adjusting order portions. According to the present example, each of the processes 300, 400, 500, 600A-B, and 700 is performed by the system 110. However, alternative implementations are possible in which any of the processes 300, 400, 500, 600A-B, and 700 is performed by a different system or a plurality of systems.

The term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid-state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method comprising:
identifying an order for a product;
dividing the order into order portions and assigning each of the order portions to a different respective supplier;
adjusting each of the order portions based on a capacity of the respective supplier to which the order portion is assigned; and
returning the order portions after the order portions have been adjusted,
wherein adjusting any given one of the order portions includes identifying a term that is associated with the given order portion, dividing the given order portion into a plurality of daily quantities that correspond to different respective days in the term, and reducing any given one of the daily quantities that fails to meet a corresponding daily capacity of the respective supplier to which the given order portion is assigned.

2. The method of claim 1, wherein the corresponding daily capacity of the respective supplier to which the given order portion is assigned is determined based on one or more order records that correspond to different orders that were placed with the respective supplier in the past.

3. The method of claim 1, wherein the corresponding daily capacity of the respective supplier to which the given order portion is assigned is determined based on an inventory of one or more materials for making the product that is available to the respective supplier on a day associated with the corresponding daily capacity.

4. The method of claim 1, wherein the corresponding daily capacity of the supplier for any given day in the term is estimated by identifying one or more days in the past that are associated with the given day in the term, identifying records for orders that are associated with the one or more days in the past, and using the identified records as a basis for calculating the corresponding daily capacity of the supplier for the given day in the term.

5. The method of claim 1, wherein reducing any given one of the daily quantities that fails to meet a corresponding daily capacity includes identifying a reduction quantity, which, if subtracted from the given daily quantity, would cause the given daily quantity to fall below a safety threshold that is associated with the corresponding daily capacity.

6. The method of claim 5, wherein the reduction amount is added to one of the order portions, other than the given order portion.

7. The method of claim 1, wherein the order is divided into order portions based on a static division rule, the static division rule being agnostic with respect to supplier capacity.

8. A method comprising:
identifying an order for a product;
dividing the order into order portions and assigning each of the order portions to a different respective supplier;
adjusting each of the order portions based on a capacity of the respective supplier to which the order portion is assigned; and
returning the order portions after the order portions have been adjusted,
wherein adjusting any given one of the order portions includes identifying a term that is associated with the given order portion, dividing the given order portion into a plurality of fractional quantities that correspond to different respective portions of the term, and reducing any given one of the fractional quantities that fails to meet a corresponding fractional capacity of the respective supplier to which the given order portion is assigned.

9. The method of claim 8, wherein the corresponding fractional capacity of the respective supplier to which the given order portion is assigned is determined based on one or more order records that correspond to different orders that were placed with the respective supplier in the past.

10. The method of claim 8, wherein the corresponding fractional capacity of the respective supplier to which the given order portion is assigned is determined based on an inventory of one or more materials for making the product that is available to the respective supplier during a portion of the term that is associated with the corresponding fractional capacity.

11. The method of claim 8, wherein the corresponding fractional capacity of the supplier for any given portion of the term is estimated by identifying one or more periods in the past that are associated with the given portion of the term, identifying records for orders that are associated with the one or more periods in the past, and using the identified records as a basis for calculating the corresponding fractional capacity of the supplier for the given portion of the term.

12. The method of claim 8, wherein reducing any given one of the fractional quantities that fails to meet a corresponding fractional capacity includes identifying a reduction quantity, which, if subtracted from the given fractional quantity, would cause the given fractional quantity to fall below a safety threshold that is associated with the corresponding fractional capacity.

13. The method of claim 12, wherein the reduction amount is added to one of the order portions, other than the given order portion.

14. The method of claim 8, wherein each of the fractional quantities includes a different daily quantity, each of the portions of the term includes a different day of the term, and any corresponding fractional capacity includes a corresponding daily capacity.

15. A system comprising:
a memory; and
at least one processor operatively coupled to the memory, the at least one processor being configured to perform the operations of:
identifying an order for a product;
dividing the order into order portions and assigning each of the order portions to a different respective supplier;
adjusting each of the order portions based on a capacity of the respective supplier to which the order portion is assigned; and
returning the order portions after the order portions have been adjusted,
wherein adjusting any given one of the order portions includes identifying a term that is associated with the given order portion, dividing the given order portion into a plurality of fractional quantities that correspond to different respective portions of the term, and reducing any given one of the fractional quantities that fails to meet a corresponding fractional capacity of the respective supplier to which the given order portion is assigned.

16. The system of claim 15, wherein the corresponding fractional capacity of the respective supplier to which the given order portion is assigned is determined based on one or more order records that correspond to different orders that were placed with the respective supplier in the past.

17. The system of claim 15, wherein the corresponding fractional capacity of the respective supplier to which the given order portion is assigned is determined based on an inventory of one or more materials for making the product that is available to the respective supplier during a portion of the term that is associated with the corresponding fractional capacity.

18. The system of claim 15, wherein the corresponding fractional capacity of the supplier for any given portion of the term is estimated by identifying one or more periods in the past that are associated with the given portion of the term, identifying records for orders that are associated with the one or more periods in the past, and using the identified records as a basis for calculating the corresponding fractional capacity of the supplier for the given portion of the term.

19. The system of claim 15, wherein reducing any given one of the fractional quantities that fails to meet a corresponding fractional capacity includes identifying a reduction quantity, which, if subtracted from the given fractional quantity, would cause the given fractional quantity to fall below a safety threshold that is associated with the corresponding fractional capacity.

20. The system of claim 15, wherein each of the fractional quantities includes a different daily quantity, each of the portions of the term includes a different day of the term, and any corresponding fractional capacity includes a corresponding daily capacity.
